(19) United States
(12) Patent Application Publication
(10) Pub. No.: US 2024/0176954 A1
(43) Pub. Date: May 30, 2024

(54) INFORMATION COMPLEMENTING APPARATUS, INFORMATION COMPLEMENTING METHOD, AND COMPUTER READABLE RECORDING MEDIUM

(71) Applicant: NEC Corporation, Minato-ku, Tokyo (JP)

(72) Inventor: Shunichi KINOSHITA, Tokyo (JP)

(73) Assignee: NEC Corporation, Minato-ku, Tokyo (JP)

(21) Appl. No.: 18/282,902

(22) PCT Filed: Mar. 23, 2021
(86) PCT No.: PCT/JP2021/011987

§ 371 Date: Sep. 19, 2023

(51) Int. Cl. G06F 40/295; G06F 40/205; G06F 40/284

(52) U.S. Cl. CPC G06F 40/295; G06F 40/205; G06F 40/284

(57) ABSTRACT

An information complementing apparatus 10 includes: a named entity extraction unit 11 that extracts named entities from a news article about a cyberattack; a dependency parsing unit 12 that parse a dependency relation between words or clauses in the news article; and a complementation processing unit 13 that specifies a named entity satisfying a set condition from among the extracted named entities and complements the specified named entity with a corresponding modifier, based on a result of the dependency relation parsing.

### TECHNICAL FIELD

The present invention relates to an information complementing apparatus and an information complementing method for assisting in searching for information regarding server attacks, and further relates to a computer readable recording medium that records a program for achieving the same.

### BACKGROUND ART

Recent years have seen an increase in cyberattacks targeting systems in government administration offices, companies, and the like, and it has become very important to ensure system security. Thus, in system operation, there is a need to collect information on cyberattacks, such as information on system vulnerabilities and information on how attacks are carried out. There is also a need to search for useful pieces of information among collected pieces of information and take necessary measures based on the useful information. Since taking measures for ensuring security involves investing in systems, obtaining useful information is also required to make business decisions.

In view of these points, for example, Non-Patent Document 1 proposes a method for structuring information on cyberattacks from security reports by using named entity recognition (NER). The security reports here are mainly reports that are provided by security vendors that perform software development and provide related services and concern security measures. The security reports provide, unlike general news articles, specialized information including the names of software programs used in cyberattacks, the IDs of common vulnerabilities and exposures (CVE), and the methods of cyberattacks.

An example of the information structured by the method disclosed in Non-Patent Document 1 is as described below. In the following example, the information includes the types of named entities on the left side and the named entities on the right side.
{“Victim”: “Company A”,
“Method of Attack”: “Targeted e-mail attack”,
“Details of Damage”: “Customer information”}

### LIST OF RELATED ART DOCUMENTS

### Non-Patent Document

Non-Patent Document 1: Shota Fujii, “Cybersecurity Intelligence Structuring Method with Named Entity Recognition in Consideration of Unknown Word”, Computer Security Symposium, collection of academic papers 2018, pages 85 to 92

### SUMMARY OF INVENTION

### Problems to be Solved by the Invention

Incidentally, when information on cyberattacks is structured using the method disclosed in Non-Patent Document 1, the information acquired by a search is “customer information” if the search query is “details of damage”, for example. However, the specific contents of the customer information is also required from the viewpoint of making investment decisions for taking necessary security measures.

An example object of the invention is to provide an information complementing apparatus, an information complementing method, and a computer readable recording medium that are capable of complementing information content in a search for information on cyberattacks.

### Means for Solving the Problems

In order to achieve the above-described object, an information complementing apparatus includes:
a named entity extraction unit that extracts named entities from a news article about a cyberattack;
a dependency parsing unit that parse a dependency relation between words or clauses in the news article; and
a complementation processing unit that specifies a named entity satisfying a set condition from among the extracted named entities and complements the specified named entity with a corresponding modifier, based on a result of the dependency relation parsing.

In order to achieve the above-described object, an information complementing method includes:
a named entity extraction step of extracting named entities from a news article about a cyberattack;
a dependency parsing step of parsing a dependency relation between words or clauses in the news article; and
a complementation processing step of specifying a named entity satisfying a set condition from among the extracted named entities and complementing the specified named entity with a corresponding modifier, based on a result of the dependency relation parsing.

In order to achieve the above-described object, a computer readable recording medium according to an example aspect of the invention is a computer readable recording medium that includes recorded thereon a program,
the program including instructions that cause the computer to carry out:
a named entity extraction step of extracting named entities from a news article about a cyberattack;
a dependency parsing step of parsing a dependency relation between words or clauses in the news article; and
a complementation processing step of specifying a named entity satisfying a set condition from among the extracted named entities and complementing the specified named entity with a corresponding modifier, based on a result of the dependency relation parsing.

### Advantageous Effects of the Invention

As described above, according to the invention, it is possible to complement information content in a search for information on cyberattacks.

### BRIEF DESCRIPTION OF THE DRAWINGS

FIG. 1 is a configuration diagram illustrating a schematic configuration of the information complementing apparatus in the example embodiment.

FIG. 2 is a configuration diagram specifically illustrating a configuration of the information complementing apparatus in the example embodiment.

FIG. 3 is a flowchart of operations of the information complementing apparatus in the example embodiment.

FIG. 4 is a diagram illustrating examples of a news article, named entity extraction results, dependency parsing results, and named entities to which modifiers have been added.

FIG. 5 is a configuration diagram illustrating a configuration of a modification of the information complementing apparatus in the example embodiment.

FIG. 6 is a block diagram illustrating an example of a computer that realizes the information complementing apparatus according to the example embodiment.

### EXAMPLE EMBODIMENT

### Example Embodiments

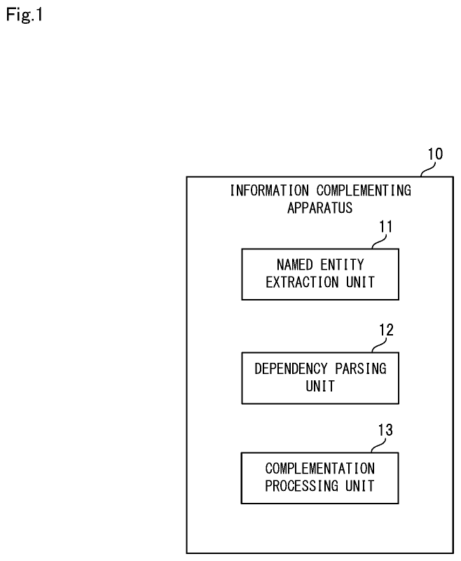

Hereinafter, an information complementing apparatus, an information complementing method, and a program in example embodiments will be described with reference to FIGS. 1 to 6.

### [Configuration of Apparatus]

First, a schematic configuration of an information complementing apparatus in an example embodiment will be described with reference to FIG. 1. FIG. 1 is a configuration diagram illustrating a schematic configuration of the information complementing apparatus in the example embodiment.

An information complementing apparatus 10 in the example embodiment illustrated in FIG. 1 is an apparatus that assists in searching for information on server attacks. As illustrated in FIG. 1, the information complementing apparatus 10 includes a named entity extraction unit 11, a dependency parsing unit 12, and a complementation processing unit 13.

The named entity extraction unit 11 extracts named entities from news articles about cyberattacks. The dependency parsing unit 12 parses dependency relations between words or between clauses in news articles. The complementation processing unit 13 specifies named entities satisfying a set condition from among the extracted named entities, and complements the specified named entities with corresponding modifiers, based on the results of parsing of the dependency relations.

As described above, in the example embodiment, the named entities extracted from the news articles about cyberattacks are complemented with modifiers. Therefore, when acquiring and structuring information on cyberattacks from news articles about cyberattacks, it is possible to make information easy to understand. As a result, according to the example embodiment, the information content is complemented in a search for information on cyberattacks.

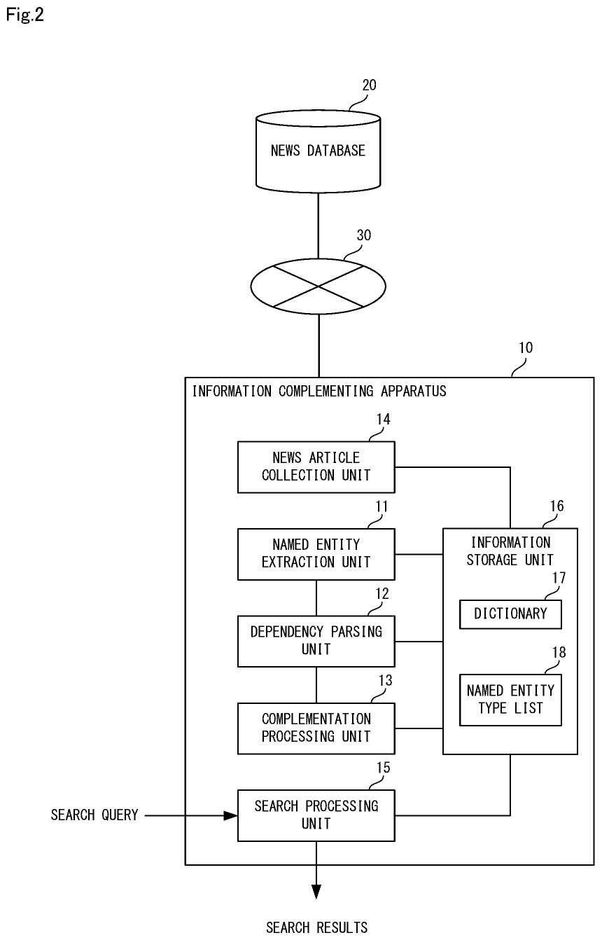

Subsequently, a configuration and functions of the information complementing apparatus in the example embodiment will be described in detail with reference to FIG. 2. FIG. 2 is a configuration diagram specifically illustrating a configuration of the information complementing apparatus in the example embodiment.

As illustrated in FIG. 2, in the example embodiment, the information complementing apparatus 10 is connected to a news database 20 so as to be capable of data communication therewith via a network 30 such as the Internet.

The news database 20 is a database in which news articles provided on the Internet are accumulated. The accumulated news articles are read by web servers and presented on web sites. In the example of FIG. 2, only one news database 20 is illustrated, but in actuality, there are many news databases 20.

As illustrated in FIG. 2, the information complementing apparatus 10 includes, in addition to the named entity extraction unit 11, the dependency parsing unit 12, and the complementation processing unit 13 described above, a news article collection unit 14, a search processing unit 15, and an information storage unit 16.

The news article collection unit 14 accesses the news database 20 via the network 30 to collect news articles. The news articles to be collected may be news articles published within a specified period of time or may be all news articles yet to be collected. The news article collection unit 14 also stores the collected news articles in the information storage unit 16.

Specifically, the news article collection unit 14 crawls news sites on the Internet in accordance with a prepared list of news sites' URLs to collect news articles. The news article collection unit 14 may also use a processing method defined for each news site to eliminate elements other than the body text of news articles at each news site and collect only the body text. An example of a news article may be “Malware X behind Company A's missing billion yen” or the like.

In the example embodiment, the named entity extraction unit 11 retrieves news articles stored in the information storage unit 16, and extracts named entities from the retrieved news articles using a dictionary 17 in which words or clauses corresponding to the named entities to be extracted are registered. The extracted named entities are stored in the information storage unit 16. The dictionary is stored in the information storage unit 16.

The types of named entities to be extracted include the attacker, the attack campaign name, the name of the malware, the name of the attack tool, the name of a damaged product, the name of a damaged website, the name of a victim, details of the damage, the amount of damage, the method of attack (for example, an ATT&CK Technique ID), the name of a vulnerability, and the like. Specifically, the extracted named entities are company A, company B, targeted e-mail attack, customer information, billion yen, and others, for example.

The named entity extraction unit 11 can also use a machine learning model to extract the named entities from news articles. In this case, the machine learning model is built by machine learning using, as training data created in advance, documents with labels indicating whether words or clauses are to be extracted.

If the labeled words or clauses include a modifier in the creation of training data, the accuracy of machine learning may be degraded. Thus, in the creation of training data, labels are preferably not added to modifiers. If the phrase “personal information including social security and tax number” is labeled, for example, the labeling is preferably corrected such that only personal information is labeled.

Further, in the example embodiment, the named entity extraction unit 11 extracts the named entities and specifies the types of the extracted named entities. In this case, the named entities and the types thereof are registered in the above-described dictionary. In the case of using a machine learning model, the machine learning is performed also with labels indicating types affixed to training data. The named entity extraction unit 11 also stores the extracted named entities in a storage area of a storage device, that is, the information storage unit 16.

In the example embodiment, the dependency parsing unit 12 parses the dependency relations between words or clauses in the news articles collected by the news article collection unit 14, using a dependency parsing algorithm. If the news articles are described in a language not including spaces like Japanese, the dependency parsing unit 12 can execute a morphological analysis and then parse the dependency relations.

As an example of the dependency parsing algorithm, there is an algorithm by which a learning model is used to calculate a likelihood that indicates whether a pair of words included in a sentence are in a dependency relation, and if the likelihood exceeds a threshold, it is determined that the words in the pair are in a dependency relation. The learning model is built by executing machine learning using, as training data, sentences and information indicating word pairs in a dependency relation in the sentences.

Taking the expression “customer information including personal information such as names” as an example, the named entity extraction unit 11 extracts “customer information” as a named entity, and sets the other words as modifiers. In this case, the dependency parsing unit 12 parses that “such as names” connects to “personal information”, “personal information” connects to “including”, and “including” connects to “customer information”.

The dependency parsing unit 12 can also calculate scores indicating the strength of a connection between words, between a word and a modifier, and between modifiers, which are parsed by the dependency parsing. The calculated scores are used in processing performed by the complementation processing unit 13. The dependency parsing unit 12 stores the results of dependency parsing in the information storage unit 16.

Taking the expression “customer information including personal information such as a name” as an example, the dependency parsing unit 12 calculates the scores of connection between “such as names” and “personal information”, between “personal information” and “including”, and between “including” and “customer information”.

In the case of using the dependency parsing algorithm described above, the dependency parsing unit 12 can use the calculated likelihoods as the scores. Note that, in the case of using an algorithm other than the aforementioned dependency parsing algorithm, numerical values for indicating the connection between words or the like are calculated in a similar manner. In this case, the dependency parsing unit 12 can use the calculated numerical values as the aforementioned scores.

In the example embodiment, the complementation processing unit 13 uses a list of types of named entities to be extracted (hereinafter, referred to as a “named entity type list”) 18 prepared in advance. The named entity type list 18 is stored in the information storage unit 16.

The complementation processing unit 13 compares the types of named entities extracted by the named entity extraction unit 11 with the named entity type list 18, and specifies the named entities whose types are registered in the named entity type list 18, from among the extracted named entities, as the named entities satisfying a set condition.

The complementation processing unit 13 specifies the modifiers related to the specified named entities from the results of dependency parsing by the dependency parsing unit 12, and complements the specified named entities with the specified modifiers. Specifically, the complementation processing unit 13 adds the specified modifiers to the named entities stored in the information storage unit 16 to associate the named entities with the modifiers. In this case, the complementation processing unit 13 can perform complementation using only the modifiers whose scores described above are greater than or equal to a threshold. Thus, a situation where the named entities are complemented with wrong modifiers is avoided.

The search processing unit 15 receives a search query that is input via an input device such as a keyboard or an external terminal apparatus, and searches the named entities stored in the information storage unit 16 based on the received search query.

Specifically, the search processing unit 15 specifies the named entities that match or are similar to the search query, from among the named entities stored in the information storage unit 16, and also specifies the modifiers associated with the specified named entities. After that, the search processing unit 15 displays the specified named entities and modifiers as the search results, on a screen of an external display apparatus, a screen of a terminal apparatus, or the like.

The complementation processing unit 13 can also complement the named entities with the modifiers described above at a timing when the search processing unit 15 executes a search. Specifically, when the search processing unit 15 searches the named entities, the complementation processing unit 13 specifies the named entities satisfying a set condition, from among the searched named entities, and complements the specified named entities with the corresponding modifiers based on the results of the dependency parsing analysis.

### [Operations of Apparatus]

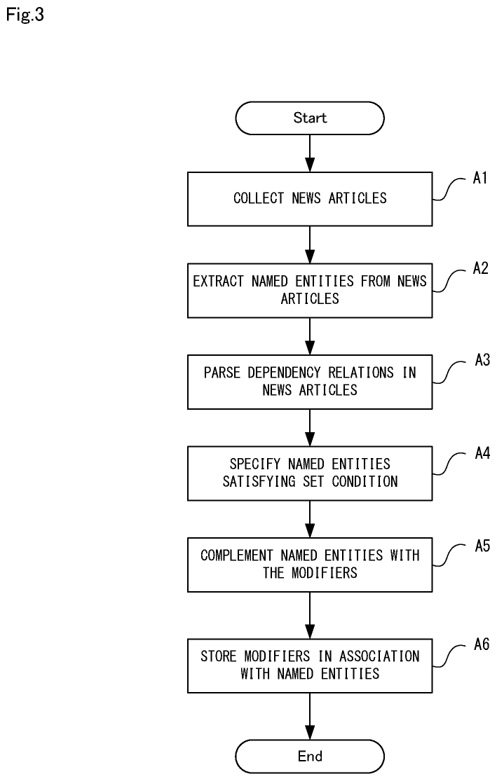

Next, operations of the information complementing apparatus 10 in the example embodiment will be described with reference to FIG. 3. FIG. 3 is a flowchart of operations of the information complementing apparatus in the example embodiment. In the following description, FIGS. 1 and 2 will be referred to as appropriate. In the example embodiment, the information complementing apparatus 10 is operated to execute an information complementing method. Therefore, the description of the information complementing method in the example embodiment is substituted with the description of operations of the information complementing apparatus 10 below.

As illustrated in FIG. 3, first, the news article collection unit 14 accesses the news database 20 via the network 30 and collects news articles (step A1). In step A1, for example, the news articles published in a specified period of time are collection targets. The collected news articles are stored in the information storage unit 16.

Next, the named entity extraction unit 11 extracts named entities from the news articles collected in step A1, using the dictionary 17 in which words or clauses corresponding to the named entities to be extracted are registered, for example (step A2).

In step A2, the named entity extraction unit 11 extracts the named entities and also specifies the types of the extracted named entities. The named entity extraction unit 11 also stores the extracted named entities in the information storage unit 16.

Next, the dependency parsing unit 12 parses the dependency relations between words or clauses in the news articles collected by the news article collection unit 14 in step A1 (step A3).

In step A3, the dependency parsing unit 12 calculates the scores indicating the strength of connection between words, between a word and a modifier, and between modifiers analyzed using the dependency parsing.

Next, the complementation processing unit 13 acquires the named entity type list 18 stored in the information storage unit 16. The complementation processing unit 13 then compares the types of the named entities extracted in step A2 with the named entity type list 18, and specifies the named entities whose types are registered in the named entity type list 18 from among the extracted named entities (step A4). The specified named entities correspond to the named entities satisfying a set condition.

The complementation processing unit 13 then specifies the modifiers that relate to the named entities specified in step A4 from the results of the dependency parsing in step A3, and complements the specified named entities with the specified modifiers (step A5).

The complementation processing unit 13 then stores the modifiers specified in step A5 together with and in association with the corresponding named entities in the information storage unit 16 (step A6). Hereinafter, the named entities and the modifiers associated with the corresponding named entities stored in the information storage unit 16 will be collectively denoted as “named entity information”.

After step A6, when a search query is input via an input device such as a keyboard or an external terminal apparatus, the search processing unit 15 accepts the search query. The search processing unit 15 then specifies the named entities matching or similar to the search query from among the named entities stored in the information storage unit 16 and also specifies the modifiers associated with the specified named entities. After that, the search processing unit 15 displays the specified named entities and modifiers as search results, on the screen of an external display apparatus, the screen of a terminal apparatus, or the like.

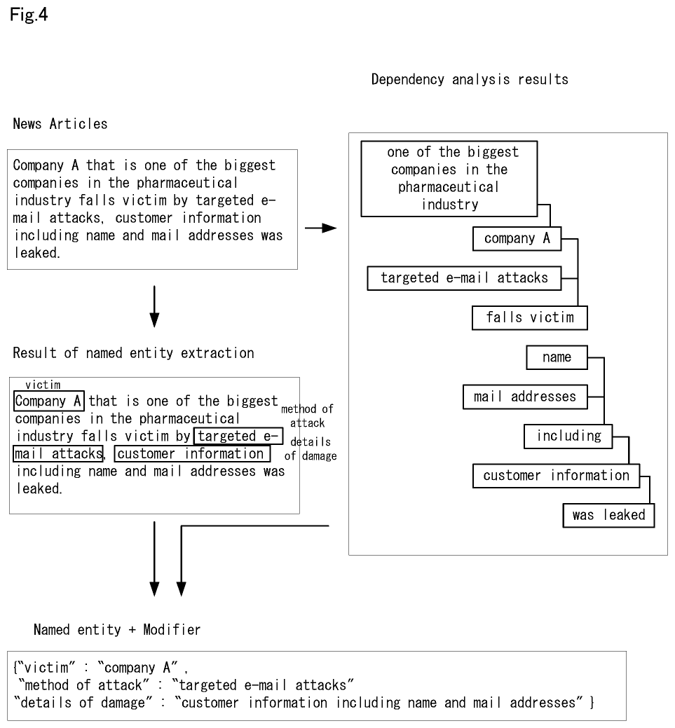

A specific example will be described with reference to FIG. 4. FIG. 4 is a diagram illustrating examples of a news article, named entity extraction results, dependency parsing results, and named entities to which modifiers have been added.

In the example of FIG. 4, the news article collection unit 14 collects a news article reporting a case of damage caused by a cyberattack “Company A, one of the biggest companies in the pharmaceutical industry, falls victim to a targeted e-mail attack in which its customer information including names and e-mail addresses was leaked”.

The named entity extraction unit 11 extracts, from the news article, the named entities “company A”, “targeted e-mail attack”, and “customer information”. The named entity extraction unit 11 also specifies the types of the named entities. In the example of FIG. 4, the named entity extraction unit 11 specifies the types of the named entities “victim”, “method of attack”, and “details of damage”.

The dependency parsing unit 12 parses the dependency relations between words or clauses in the above news article. As a result, “one of the biggest companies in the pharmaceutical industry” connects to “company A”, “company A” and “targeted e-mail attacks” connect to “falls victim”, “names” and “mail addresses” connect to “including”, and “including” connects to “customer information”. Also, “customer information” connects to “was leaked”.

In the example of FIG. 4, only “details of damage” is registered in the named entity type list. Therefore, the complementation processing unit 13 determines that “customer information” among the extracted named entities is the target of complementation by the modifiers, and complements “customer information” with a direct modifier and an indirect modifier. In the example of FIG. 4, the complementation processing unit 13 corrects “including names and e-mail addresses” to “customer information”.

As described above, according to the example embodiment, the named entities extracted from the news article are complemented with the modifiers. Thus, if named entities are searched for in order to acquire information on a cyberattack, the content of the information is complemented. Consequently, the complemented information is also useful in investment decisions for taking necessary security measures.

### Modifications

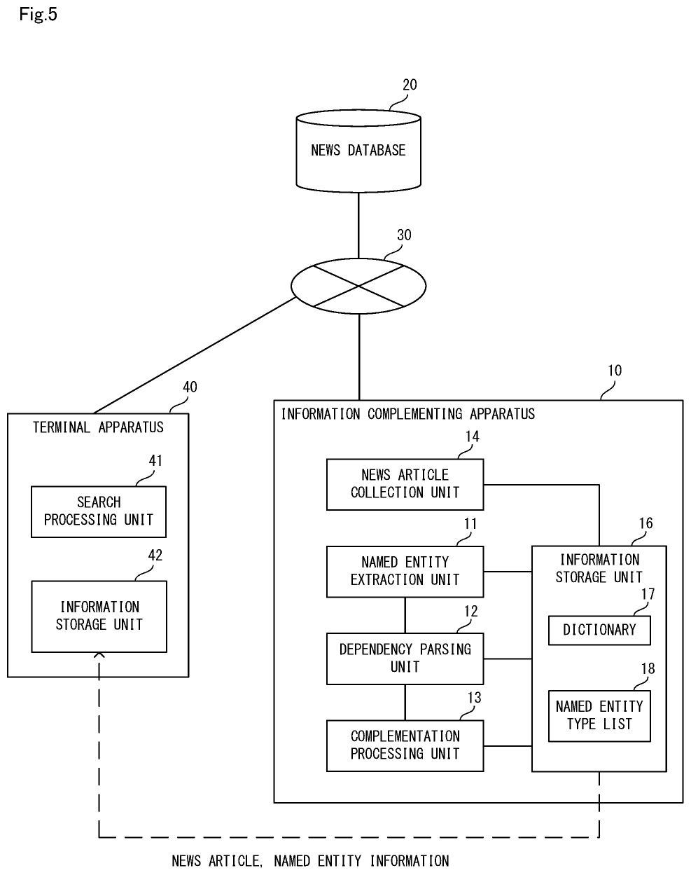

A modification of the information complementing apparatus 10 in the example embodiment will be described with reference to FIG. 5. FIG. 5 is a configuration diagram illustrating a configuration of a modification of the information complementing apparatus in the example embodiment.

As illustrated in FIG. 5, in the modification, unlike in the example illustrated in FIG. 2, the information complementing apparatus 10 does not include a search processing unit. Otherwise the information complementing apparatus 10 is the same as that illustrated in FIG. 2.

In the modification, the information complementing apparatus 10 is connected, via a network 30, to a terminal apparatus 40 used by a searcher. The terminal apparatus 40 includes a search processing unit 41 that is similar to the search processing unit 15 illustrated in FIG. 2, and an information storage unit 42.

In the modification, upon completion of complementation of named entities with modifiers, the information complementing apparatus 10 transmits a news article and the named entity information including the complementary modifiers to the terminal apparatus 40, via the network 30. When the news article and the named entity information are transmitted, the terminal apparatus 40 stores the same in the information storage unit 42.

According to this configuration, the searcher can input a search query to the terminal apparatus 40. In this case, the search processing unit 41 accesses the information storage unit 42 of the terminal apparatus 40 to specify named entities matching or similar to the search query and modifiers associated with the named entities, from among the named entities stored in the information storage unit 42. Then the search processing unit 41 displays the specified named entities and modifiers on a screen of the terminal apparatus 40.

According to the modification, the information complementing apparatus 10 does not need to include a search function, which reduces the cost of the information complementing apparatus 10. In addition, according to the modification, since no search query is transmitted from the terminal apparatus 40 to the information complementing apparatus 10, it is possible to eliminate the possibility that an administrator of the information complimenting apparatus 10 is made aware of a search query.

### [Programs]

A program in the example embodiment is program for causing a computer to execute steps A1 to A6 illustrated in FIG. 3. This program can be installed in the computer and executed by the computer to implement the information complementing apparatus and the information complementing method according to the example embodiment. In this case, the processor of the computer functions as the named entity extraction unit 11, the dependency parsing unit 12, the complementation processing unit 13 and the news article collection unit 14 to perform the processing. The computer may be a general-purpose PC, a smartphone, or a tablet terminal device.

Furthermore, in the example embodiment, the information storage unit 16 may be realized by storing data files constituting the information storage unit 16 in a storage device such as a hard disk provided in the computer, or may be realized by a storage device provided in another computer.

The program in the example embodiment may be executed by a computer system that is built by a plurality of computers. In this case, the computers may each function as the named entity extraction unit 11, the dependency parsing unit 12, the complementation processing unit 13 and the news article collection unit 14, for example.

### [Physical Configuration]

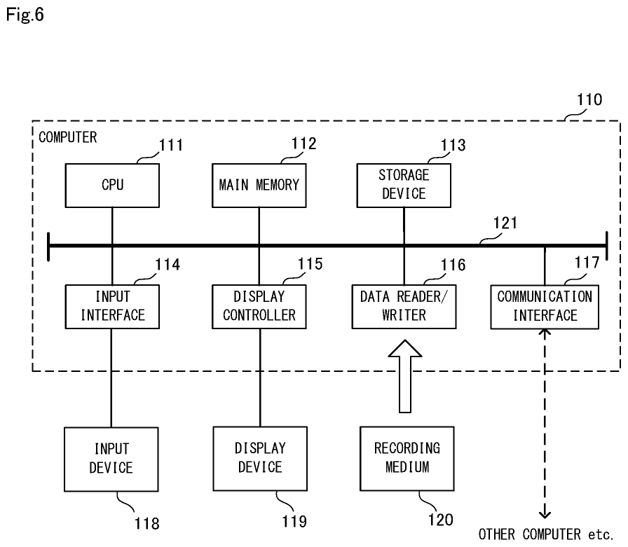

Using FIG. 6, the following describes a computer that realizes the information complementing apparatus 10 by executing the program according to the example embodiment. FIG. 6 is a block diagram illustrating an example of a computer that realizes the information complementing apparatus according to the example embodiment.

As shown in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information complementing apparatus 10 according to the example embodiment can also be realized by using items of hardware that respectively correspond to the components rather than the computer in which the program is installed. Furthermore, a part of the information complementing apparatus 10s according to the example embodiment may be realized by the program, and the remaining part of the information complementing apparatus 10 may be realized by hardware.

A part or an entirety of the above-described example embodiment can be represented by (Supplementary Note 1) to (Supplementary Note 15) described below but is not limited to the description below.

### (Supplementary Note 1)

An information complementing apparatus comprising:
a named entity extraction unit that extracts named entities from a news article about a cyberattack;
a dependency parsing unit that parses dependency relation between words or clauses in the news article; and
a complementation processing unit that specifies a named entity satisfying a set condition from among the extracted named entities and complements the specified named entity with a corresponding modifier, based on a result of the dependency relation parsing.

### (Supplementary Note 2)

The information complementing apparatus according to Supplementary Note 1,
wherein the named entity extraction unit extracts the named entities and specifies types of the extracted named entities, and
the complementation processing unit compares the types of the extracted named entities with a list of types of named entities to be extracted prepared in advance, and specifies the named entity whose type is registered in the list from among the extracted named entities, as a named entity satisfying the set condition.

### (Supplementary Note 3)

The information complementing apparatus according to Supplementary Note 1 or 2,
wherein the named entity extraction unit stores the extracted named entities in a storage area of a storage device, and
if a search process is performed on the named entities stored in the storage area to search the named entities, the complementation processing unit specifies a named entity satisfying the set condition from among the searched named entities, and complements the specified named entity with a corresponding modifier based on the result of the dependency relation parsing.

### (Supplementary Note 4)

The information complementing apparatus according to any of Supplementary Notes 1 to 3,
wherein the named entity extraction unit extracts the named entities from the news article, using a dictionary in which words or clauses corresponding to the named entities to be extracted are registered.

### (Supplementary Note 5)

The information complementing apparatus according to any of Supplementary Notes 1 to 4,
wherein the named entity extraction unit extracts the named entities from the news article using a machine learning model, and
the machine learning model is built using a document with a label indicating whether words or clauses are to be extracted, as training data.

### (Supplementary Note 6)

An information complementing method comprising:
a named entity extraction step of extracting named entities from a news article about a cyberattack;
a dependency parsing step of parsing a dependency relation between words or clauses in the news article; and
a complementation processing step of specifying a named entity satisfying a set condition from among the extracted named entities and complementing the specified named entity with a corresponding modifier, based on a result of the dependency relation parsing.

### (Supplementary Note 7)

The information complementing method according to Supplementary Note 6, further comprising:
in the named entity extraction step, extracting the named entities and specifying types of the extracted named entities, and
in the complementation processing step, comparing the types of the extracted named entities with a list of types of named entities to be extracted prepared in advance, and specifying the named entity whose type is registered in the list from among the extracted named entities, as a named entity satisfying the set condition.

### (Supplementary Note 8)

The information complementing method according to Supplementary Note 6 or 7, further comprising:
in the named entity extraction step, storing the extracted named entities in a storage area of a storage device, and
if a search process is performed on the named entities stored in the storage area to search the named entities, in the complementation processing step, specifying a named entity satisfying the set condition from among the searched named entities, and complementing the specified named entity with a corresponding modifier based on the result of the dependency relation parsing.

### (Supplementary Note 9)

The information complementing method according to any of Supplementary Notes 6 to 8, further comprising,
in the named entity extraction step, extracting the named entities from the news article using a dictionary in which words or clauses corresponding to the named entities to be extracted are registered.

### (Supplementary Note 10)

The information complementing method according to any of Supplementary Notes 6 to 9, further comprising,
in the named entity extraction step, extracting the named entities from the news article using a machine learning model,
wherein the machine learning model is built using a document with a label indicating whether words or clauses are to be extracted, as training data.

### (Supplementary Note 11)

A computer readable recording medium that includes a program recorded thereon, the program including instructions that cause a computer to carry out:
a named entity extraction step of extracting named entities from a news article about a cyberattack;
a dependency parsing step of parsing a dependency relation between words or clauses in the news article; and
a complementation processing step of specifying a named entity satisfying a set condition from among the extracted named entities and complementing the specified named entity with a corresponding modifier, based on a result of the dependency relation parsing.

### (Supplementary Note 12)

The computer readable recording medium according to Supplementary Note 11,
in the named entity extraction step, extracting the named entities and specifying types of the extracted named entities, and
in the complementation processing step, comparing the types of the extracted named entities with a list of types of named entities to be extracted prepared in advance, and specifying the named entity whose type is registered in the list from among the extracted named entities, as a named entity satisfying the set condition.

### (Supplementary Note 13)

The computer readable recording medium according to Supplementary Note 11 or 12,
in the named entity extraction step, storing the extracted named entities in a storage area of a storage device, and
if a search process is performed on the named entities stored in the storage area to search the named entities, in the complementation processing step, specifying a named entity satisfying the set condition from among the searched named entities, and complementing the specified named entity with a corresponding modifier based on the result of the dependency relation parsing.

### (Supplementary Note 14)

The computer readable recording medium according to any of Supplementary Notes 11 to 13,
in the named entity extraction step, extracting the named entities from the news article using a dictionary in which words or clauses corresponding to the named entities to be extracted are registered.

### (Supplementary Note 15)

The computer readable recording medium according to any of Supplementary Notes 11 to 14,
in the named entity extraction step, extracting the named entities from the news article using a machine learning model,
wherein the machine learning model is built using a document with a label indicating whether words or clauses are to be extracted, as training data.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the invention, it is possible to complement information content in a search for information on cyberattacks. The present invention is useful in various fields where analysis of cyberattacks is required.

### REFERENCE SIGNS LIST

10 Information complementing apparatus
11 Named entity extraction unit
12 Dependency parsing unit
13 Complementation processing unit
14 News article collection unit
15 Search processing unit
16 Information storage unit
17 Dictionary
18 Named entity type list
20 News database
30 Network
40 Terminal apparatus
41 search processing unit
42 information storage unit
110 Computer
111 CPU
112 Main memory
113 Storage device
114 Input interface
115 Display controller
116 Data reader/writer
10) 117 Communication interface
118 Input device
119 Display device
120 Recording medium
121 Bus

What is claimed is:

1. An information complementing apparatus comprising:
at least one memory storing instructions; and
at least one processor configured to execute the instructions to:
extract named entities from a news article about a cyberattack;
parse a dependency relation between words or clauses in the news article; and
specify a named entity satisfying a set condition from among the extracted named entities and complement the specified named entity with a corresponding modifier, based on a result of the dependency relation parsing.

2. The information complementing apparatus according to claim 1,
further at least one processor configured to execute the instructions to:
extract the named entities and specifies types of the extracted named entities, and
compare the types of the extracted named entities with a list of types of named entities to be extracted prepared in advance, and specify the named entity whose type is registered in the list from among the extracted named entities, as a named entity satisfying the set condition.

3. The information complementing apparatus according to claim 1,
further at least one processor configured to execute the instructions to:
store the extracted named entities in a storage area of a storage device, and
specify, if a search process is performed on the named entities stored in the storage area to search the named entities, a named entity satisfying the set condition from among the searched named entities, and complement the specified named entity with a corresponding modifier based on the result of the dependency relation parsing.

4. The information complementing apparatus according to claim 1,
further at least one processor configured to execute the instructions to:
extract the named entities from the news article, using a dictionary in which words or clauses corresponding to the named entities to be extracted are registered.

5. The information complementing apparatus according to claim 1,
further at least one processor configured to execute the instructions to:
extract the named entities from the news article using a machine learning model, and
the machine learning model is built using a document with a label indicating whether words or clauses are to be extracted, as training data.

6. An information complementing method comprising:
extracting named entities from a news article about a cyberattack;
parsing a dependency relation between words or clauses in the news article; and
specifying a named entity satisfying a set condition from among the extracted named entities and complementing the specified named entity with a corresponding modifier, based on a result of the dependency relation parsing.

7. The information complementing method according to claim 6, further comprising:
in the extracting the named entities, extracting the named entities and specifying types of the extracted named entities, and
in the complementing, comparing the types of the extracted named entities with a list of types of named entities to be extracted prepared in advance, and specifying the named entity whose type is registered in the list from among the extracted named entities, as a named entity satisfying the set condition.

8. The information complementing method according to claim 6, further comprising:
in the extracting the named entities, storing the extracted named entities in a storage area of a storage device, and
if a search process is performed on the named entities stored in the storage area to search the named entities, in the complementing, specifying a named entity satisfying the set condition from among the searched named entities, and complementing the specified named entity with a corresponding modifier based on the result of the dependency relation parsing.

9. The information complementing method according to claim 6, further comprising,
in the extracting the named entities, extracting the named entities from the news article using a dictionary in which words or clauses corresponding to the named entities to be extracted are registered.

10. The information complementing method according to claim 6, further comprising,
in the extracting the named entities, extracting the named entities from the news article using a machine learning model,
wherein the machine learning model is built using a document with a label indicating whether words or clauses are to be extracted, as training data.

11. A non-transitory computer readable recording medium that includes a program recorded thereon, the program including instructions that cause a computer to carry out:
extracting named entities from a news article about a cyberattack;
parsing a dependency relation between words or clauses in the news article; and
specifying a named entity satisfying a set condition from among the extracted named entities and complementing the specified named entity with a corresponding modifier, based on a result of the dependency relation parsing.

12. The non-transitory computer readable recording medium according to claim 11,
wherein the extracting the named entities includes extracting the named entities and specifying types of the extracted named entities, and
the complementing includes comparing the types of the extracted named entities with a list of types of named entities to be extracted prepared in advance, and specifying the named entity whose type is registered in the list from among the extracted named entities, as a named entity satisfying the set condition.

13. The non-transitory computer readable recording medium according to claim 11,
wherein the extracting the named entities includes storing the extracted named entities in a storage area of a storage device, and
if a search process is performed on the named entities stored in the storage area to search the named entities, the complementing includes specifying a named entity satisfying the set condition from among the searched named entities, and complementing the specified named entity with a corresponding modifier based on the result of the dependency relation parsing.

14. The non-transitory computer readable recording medium according to claim 11, wherein the extracting the named entities includes extracting the named entities from the news article using a dictionary in which words or clauses corresponding to the named entities to be extracted are registered.

15. The non-transitory computer readable recording medium according to claim 11,
wherein the extracting the named entities includes extracting the named entities from the news article using a machine learning model, and
the machine learning model is built using a document with a label indicating whether words or clauses are to be extracted, as training data.
